(19) United States
(12) Patent Application Publication
(10) Pub. No.: US 2024/0397066 A1
(43) Pub. Date: Nov. 28, 2024

(54) RATE-CONTROL USING MACHINE VISION PERFORMANCE

(71) Applicant: Telefonaktiebolaget LM Ericsson (publ), Stockholm (SE)

(72) Inventors: Christopher HOLLMANN, Uppsala (SE); Jacob STRÖM, Stockholm (SE)

(21) Appl. No.: 18/693,331

(22) PCT Filed: Sep. 13, 2022
(86) PCT No.: PCT/SE2022/050809

§ 371 Date: Mar. 19, 2024

Related U.S. Application Data
(60) Provisional application No. 63/249,229, filed on Sep. 28, 2021.

(51) Int. Cl. H04N 19/20; H04N 19/136; H04N 19/172; H04N 19/184; H04N 19/423

(52) U.S. Cl. CPC H04N 19/20; H04N 19/136; H04N 19/172; H04N 19/184; H04N 19/423

(57) ABSTRACT

A method by a control system includes receiving at least one of an image, a video frame, or a point cloud frame. Responsive to detecting an object of a group of classes of a predefined group of classes in the at least one of the image, the video frame, or the point cloud frame, setting a target bit rate of an encoder to a specific value based on the object. Responsive to not detecting any object that belongs to any of the predefined group of classes in the at least one of the image, the video frame, or the point cloud frame, setting the target bit rate to one of a default bit rate and a current bit rate. The method includes sending an instruction to the encoder of a bit rate to use based on whether an object is detected.

### TECHNICAL FIELD

The present disclosure relates generally to communications, and more particularly to communication methods and related devices and nodes supporting wireless communications.

### BACKGROUND

A known problem in video transmission or storage systems is that of rate control. In rate control, the bit rate of the transmission is controlled so that it gives satisfactory quality to the end user watching the video, while at the same time making sure that the bit rate of the encoded video does not surpass the capacity of the transmission network, or the storage capacity of a storage device.

If no rate control is used, the encoder can work at a fixed quantization setting, more or less giving a constant error all the time. This approach is sometimes referred to as “fixed QP” or “variable bit rate” (VBR). It may produce a reasonable bit rate for “easy” content, i.e., content that can be compressed to low bit rates with good quality, but “hard” content may produce a bit rate that exceeds the capacity of the transmission link or the storage device. Examples of easy content include nearly static scenes such as a surveillance camera watching an empty building, and examples of hard content include scenes with lots of complicated motion such as a basketball game or a scene where people move quickly close to the camera.

Several strategies for rate control exist. One strategy is to get as close as possible to the capacity ceiling while never overshooting it, in order to give the best possible quality to the end user. Methods using this strategy use only the bit rate to control the encoder. As an example, if the previous frame was encoded with too many bits, the following frame may be compressed harder so that the average bit rate of the two frames still undershoots the capacity target. No consideration of the quality needs to be taken when controlling the bit rate, since the strategy is to always increase the bit rate until the capacity limit is reached.

Another approach is to stop increasing the bit rate even before reaching the capacity limit if it is determined that the quality is already sufficient. This approach shall be referred to as the “sufficient quality strategy”. This approach can save bandwidth for “easy” content, i.e., content that can be compressed to low bit rates with good quality, while maintaining quality for “hard” content by increasing the bit rate to the capacity limit. Such methods need to somehow estimate the quality of the encoded material to be able to throttle quality for easy content. One way is to calculate the error between the reconstructed video picture (which are equivalent to encoding and then decoding the picture) and the originals, for instance using mean square error (MSE) in accordance with

$$M S E = \frac{1}{NM} {\sum }_{x , y}^{N , M} {( rec ( x , y ) - orig ( x , y ) )}^{2}$$

where rec(x, y) is the luminance or luma value of the reconstructed picture in sample position (x, y), orig(x, y) is the luma value of the original picture and N and M are the width and height of the picture respectively. If the MSE for an individual picture (or the average MSE over a number of pictures) is deemed too high, the encoder can be instructed to increase the bit rate.

A similar approach is to use peak signal to noise ratio (PSNR), which can be calculated from MSE using

$$PSNR = 10 {log}_{10} ( \frac{{P}^{2}}{M S E} ) ,$$

where P is the largest possible value of the luma value, for instance 255 for 8-bit material. A higher PSNR score means a higher fidelity picture, so here the strategy could be to increase bit rate until the average PSNR for a number of frames is above, say, 38 dB, or the capacity limit has been reached, whichever comes first.

Other distortion metrics or quality indicators can also be used. As an example, Multi-Scale Structural Similarity (MS-SSIM) has been reported to be better at predicting the perceived quality as seen by an end user than MSE-based PSNR.

A problem with existing solutions applying the “sufficient quality strategy” is that they assume that humans will be consuming the video in the end. This is a reasonable strategy in traditional applications. As an example, a video streaming service like Netflix is meant to be consumed by people, and the output of a video surveillance system is meant to be investigated by forensic experts. However, in many new and upcoming applications, it is machine vision systems rather than humans that are the intended audience. This means that previous distortion metrics or quality measures such as MSE, PSNR and MS-SSIM that are created with human vision in mind are not necessarily helpful for computer vision tasks. As an example, it may be possible for a computer vision system to reliably identify a certain object at a much lower bit rate than a human can, while for another object, the machine vision system needs more bit rate than a human to complete the task. Therefore, existing solutions will often undershoot or overshoot the bit rate target when using distortion metrics or quality measures that have been created with a human observer in mind. This may lead to an inefficient spending of bits or image quality that is too low for the system to correctly carry out its machine vision tasks.

In the area of still image compression, there have been recent attempts at finding a better bit allocation system for machine vision systems. In the C. Hollmann, P. Wennersten, J. Ström, L. Litwic. “[VCM] VCM-based rate-distortion optimization for VVC”, ISO/IEC JTC 1 SC29 WG2 m56634, April 2021 document, the image is compressed at four different resolutions (100%, 75%, 50% and 25%), and each resolution is compressed at several fixed QPs (22, 27, 32, 37, 42 and 47), resulting in 4*6=24 different compressed representations. The machine vision task is run on all these 24 representations, and a score is calculated that takes into account both the bit rate and how well the machine vision task is handled compared to running it on the uncompressed image. This method can avoid spending unnecessary bits if the machine vision task is already perfectly accomplished by lowering the resolution and increasing the QP.

For the case of video compression, there are different aspects an encoder can modify. While it may be unreasonable to compress a video stream at 24 different compression points, decisions can be made to adjust the encoder for future frames. One way is to analyze a current frame and make decisions for future frames based on the discovered content. An example of an implementation of such a system is described in the whitepaper by Axis Communications titled “Axis Zipstream technology”, Whitepaper, January 2018. Here three different aspects of the encoding can be adjusted:
Region of Interest (ROI): A part of the video is encoded with higher quality than the remaining video
Group of Pictures (GOP): Based on the content, I-frames (which are independent from other frames) can be omitted to reduce the bitrate when very little motion is detected
Frames per Second (FPS): When little change in the content is detected, the number of encoded frames per second can be reduced. In some cases, this might be solved by sending empty frames (frames only consisting of skip blocks) instead of the actual video frames to keep the appearance of a constant frame rate up.

The system described in the whitepaper is a video encoder implementation, meaning that all processing and analyzing of the videos happens in the encoder.

There currently exist certain challenge(s). As described above, many existing techniques either target video compression systems where the end user is assumed to be a human or target still image compression systems. Since the work in the document “VCM-based rate-distortion optimization for VVC” targets still image compression, it may be feasible to recompress the image 24 times. However, for video compression, with several frames per second compressed per second, an overhead of 24 times may not be feasible in terms of needed silicon area, cost or power consumption.

Regarding the system in the whitepaper described above, it might be an advantage to control several cameras with a central system without giving each camera control over the transmitted data. For example, if two cameras have adjacent fields of view and a person moves from one to the other, the second camera might be at a very low bit rate and might get a spike in bit rate when increasing the quality to match the quality of the previous camera. However, in the time that it takes to adjust the bit rate, valuable information might be lost.

Another data type that has gathered more and more attention over the last years is point cloud data. A point cloud consists of any number of points that are defined by a set of coordinates and a color. While most common point clouds are used to represent a three-dimensional environment, there are no theoretic limits to the number of dimensions. The color information can be of any format, leaving great flexibility. There can also be attributes other than color associated with each point, such as normal vectors. There has been some research on the usage of point clouds in surveillance, for example in the literature by Benedek, Csaba and titled “3D people surveillance on range data sequences of a rotating Lidar.” Pattern Recognition Letters 50 (2014): 149-158. This research seems to focus on the general usability and challenges for specific use cases.

### SUMMARY

Certain aspects of the disclosure and their embodiments may provide solutions to these or other challenges. In various embodiments of inventive concepts, a sensor, an encoder, and a control system are provided. The control system contains a machine vision algorithm as well as, in some cases, a decoder. The control system can be placed either on the encoder side in close proximity to the sensor and the encoder, or in a remote setting. The control system can influence the encoder to change the bit rate of the encoding based on the content that is being detected.

According to some embodiments of inventive concepts, a method performed by a control system having a machine vision algorithm includes receiving at least one of an image, a video frame, or a point cloud frame. The method includes responsive to detecting an object of a group of classes of a predefined group of classes in the at least one of the image, the video frame, or the point cloud frame, setting a target bit rate of an encoder to a specific value based on the object. The method includes responsive to not detecting any object that belongs to any of the predefined group of classes in the at least one of the image, the video frame, or the point cloud frame, setting the target bit rate to one of a default bit rate and a current bit rate. The method includes sending an instruction to the encoder of a bit rate to use based on whether an object is detected.

Control system apparatuses, computer programs, and computer program products having similar recitations are also provided.

Certain embodiments may provide one or more of the following technical advantage(s). The various embodiments can control a multitude of video sensors and adjust the bit rate of the encoders based on the content that is discovered by the sensors. The control system can be adjusted to work for many different use cases.

According to some other embodiments of inventive concepts, a method performed by a control system having a machine vision algorithm includes receiving at least one frame from an encoder. The method includes using the machine vision algorithm for detection and classification of one or more objects in the at least one frame, the machine vision algorithm producing a score indicating how certain the machine vision algorithm is about the detection and classification of the one or more objects. The method includes sending an instruction to the encoder to use a new bit rate or a modification of a current target bit rate based on the score responsive to one or more objects being detected.

Control system apparatuses, computer programs, and computer program products having similar recitations are also provided.

According to yet other embodiments of inventive concepts, a method by an encoder configured to use different bit rates includes encoding video frames at a lowest bit rate of the different bit rates. The method includes filling a buffer with one of uncompressed sensor output or with encoding at a highest bit rate of the different bit rates. The method includes sending at least one frame to a control system for analysis. The method includes receiving an instruction from the control system to encode at a specified bit rate. The method includes encoding data in the buffer at the specified bit rate.

Encoder apparatuses, computer programs, and computer program products having similar recitations are also provided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a signaling diagram illustrating communications between an encoder, a control system and a machine vision algorithm according to some embodiments of inventive concepts;

FIG. 2 is a signaling diagram illustrating communications between an encoder, a control system and a machine vision algorithm according to some other embodiments of inventive concepts;

FIG. 3 is a block diagram illustrating an encoder compressing a video at two different bit rates, a high bit rate and a low bit rate with the bit rate being controlled by a control system according to various embodiments of inventive concepts;

FIG. 4 is a block diagram illustrating an encoder compressing a video at a target bit rate specified by a control system according to various embodiments of inventive concepts;

FIG. 5 is a block diagram illustrating an encoder compressing a video at a target bit rate specified by a control system according to various embodiments of inventive concepts;

FIG. 6 is a block diagram illustrating an environment in which the encoder and control system operates in various embodiments of inventive concepts;

FIG. 7 is a block diagram illustrating of a virtualization environment in accordance with some embodiments;

FIG. 8 is a block diagram illustrating a control system according to some embodiments of inventive concepts;

FIG. 9 is a block diagram illustrating an encoder according to some embodiments of inventive concepts;

FIGS. 10-14 are flow charts illustrating operations of a control system according to some embodiments of inventive concepts;

FIGS. 15-16 are flow charts illustrating operations of an encoder according to some embodiments of inventive concepts.

### DETAILED DESCRIPTION

Some of the embodiments contemplated herein will now be described more fully with reference to the accompanying drawings, in which examples of embodiments of inventive concepts are shown. Embodiments are provided by way of example to convey the scope of the subject matter to those skilled in the art. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, the various embodiments of inventive concepts provide a system which adjust the bit rate for encoding content captured by a sensor with the purpose to retain a high quality for objects or events of interest while reducing the bit rate for uninteresting content.

As an example, for a system that is built to track vehicles and pedestrians, a higher bit rate may be needed if pedestrians are present in the scene, since they are relatively small compared to a vehicle. Thus, if the system detects that a pedestrian enters the scene, the system can order the encoder to increase the bit rate, ensuring that future frames will be of sufficient quality for processing at the decoder.

The various embodiments of inventive concepts provide a system that controls the bit rate of an encoder based on the content that is detected by a machine vision (MV) algorithm, which analyzes the input from a video sensor. Based on the configuration of the system, the system can either set a target bit rate for the encoder, or, if a different means of quality control such as VBR is preferred, adjust the quality of the encoded video in a different manner.

The control system can either be directly connected to the encoder or it can be placed remotely, for example in the cloud. If the control system is in the cloud, the encoder can compress at least one frame and send it to the control system, which in turn analyzes the transmitted data and returns an instruction to the encoder, indicating a bit rate configuration for the encoder to use.

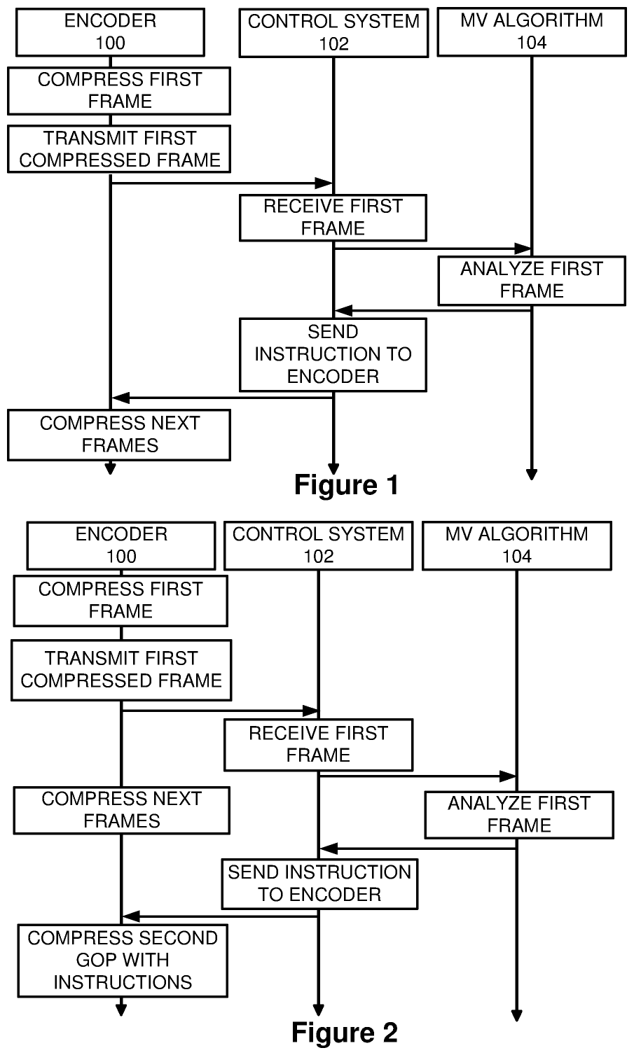

If the latency between the cloud and the encoder is very low, it might be that the encoder compresses a single frame (i.e., an I-frame), transmits it, the control system feeds it to the machine vision algorithm, retrieves the analysis, and transmits an instruction to the encoder what kind of bit rate configuration to use for the following frames. A schematic of this process can be found in FIG. 1.

If the latency is too large for this kind of direct interaction, the encoder uses a predetermined configuration to compress the following frames, for example the next group of pictures (GOP). Once the control system has processed the transmitted frame, it again sends an instruction to the encoder. As the encoder has already processed the following frames, it will apply the new instruction to the following GOP. An example of this process can be found in FIG. 2.

The control system in some embodiments contains a decoder. Some machine vision algorithms need decoded video frames to work, whereas others can analyze the compressed video stream. In some cases, a decoder might be present, but if the machine vision algorithm works on compressed video streams, the control system passes the received stream directly to the machine vision algorithm without decoding it first.

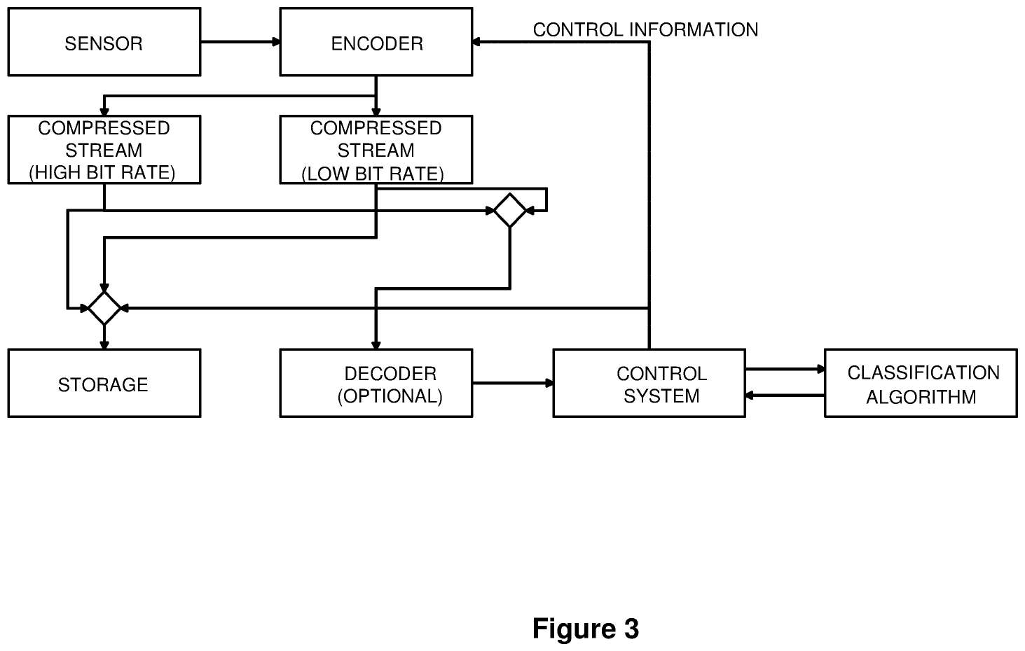

In some other embodiments of inventive concepts, the encoder compresses the video at two different bit rates, a high bit rate and a low bit rate. Both compressed videos are stored locally. The control system analyzes the video with the MV algorithm. If an object or event of interest is registered, the control system instructs the encoder to store the stream compressed at the high bit rate and to potentially remove the stream compressed at the low bit rate, otherwise if nothing interesting is registered, the low bit rate stream is stored and the high bite rate stream removed. An example using two different bit rates is shown in FIG. 3. Note that in FIG. 3, both the high bit rate stream and the low bit rate stream can be transmitted to the control system. Most implementations would choose just a single stream to be transmitted. Dashed lines in the graphic indicate control information whereas solid lines indicate data flows.

In another implementation, the control system instructs the encoder to increase the bit rate for only a part of the video. This might not be a fixed area for all concerned frames but could be a moving area to account for moving objects.

In a further implementation, the MV algorithm provides a score indicating how confident it is about the correct classification of a detected object. The control system might then send an instruction to the encoder to adjust the bit rate based on the confidence score, for example if the confidence score is high, the bit rate can be lowered or if the confidence score is low, the bit rate can be increased.

In yet another implementation, the control system can serve multiple sensors with adjacent fields of view. If the system detects that one object is moving towards the field of view of an adjacent sensor which is operating at a low bit rate, it can increase the bit rate of the encoder for the adjacent sensor over time, avoiding a spike in the bit rate when the object comes into the field of view for the adjacent sensor.

In some embodiments of inventive concepts, the sensor is generating point cloud data instead of video. All the previous implementations described above can also be applied to this type of data instead of video data.

### Embodiments

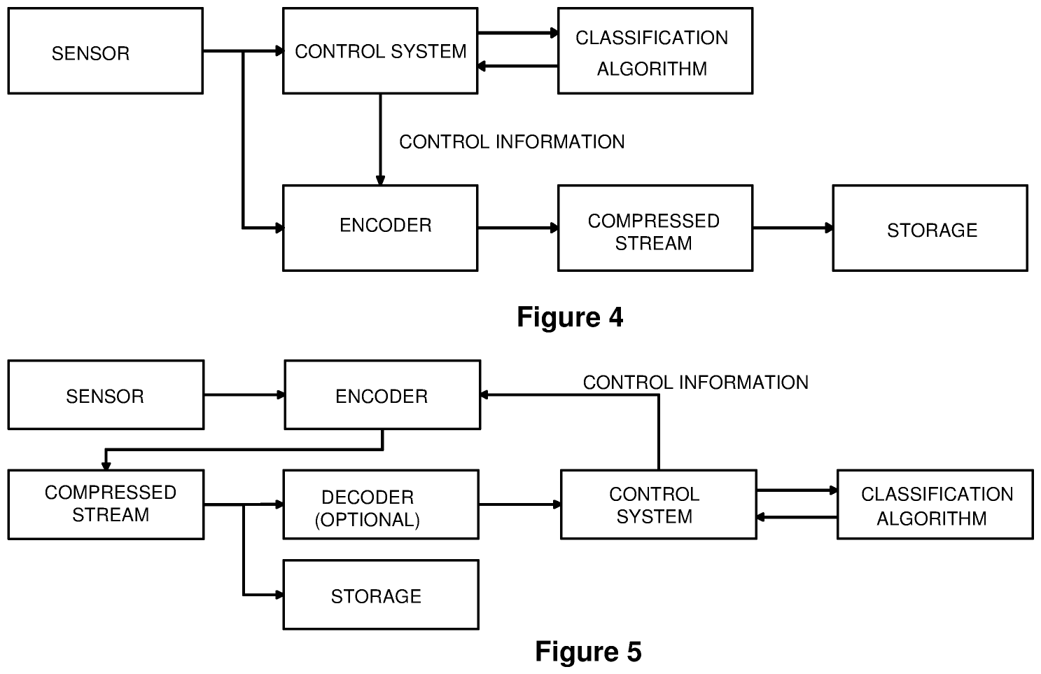

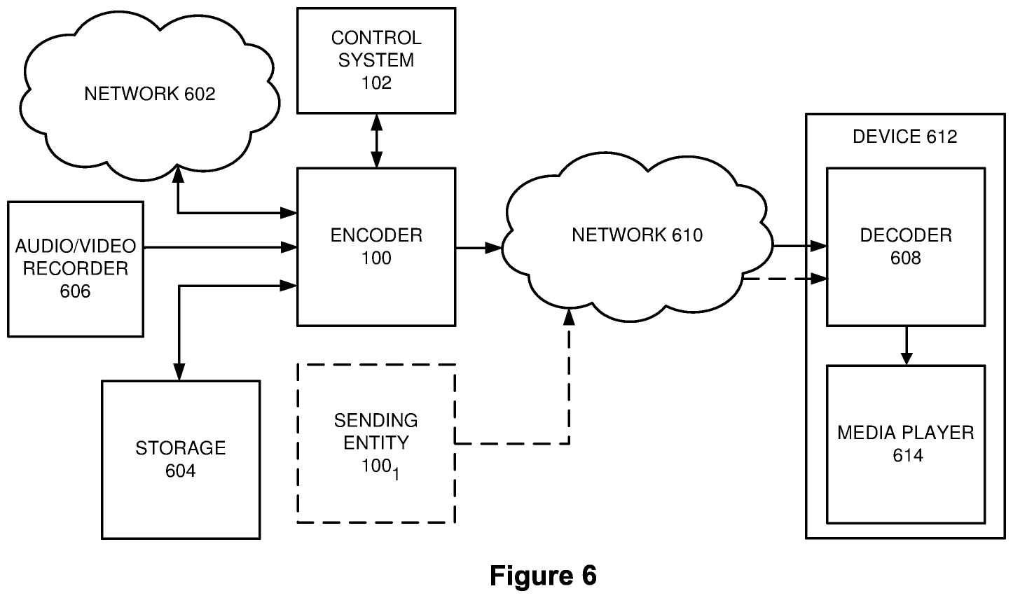

In some embodiments of inventive concepts, a MV algorithm with a specific task is run on an image, video frame or a point cloud frame. If an object of a predefined group of classes is detected, the target bit rate of the encoder is set to a specific value. If no object that belongs to a specific class is detected, the target bit rate is set to a default value. A schematic drawing is illustrated in FIG. 4.

An example of grouping and detection is below:
Grouping:
   Group of classes A: car, person, bus—target bit rate 10 Mbps
   Group of classes B: bike, dog, train—target bit rate 1 Mbps
   Default target bit rate—100 kbps
Detection:
   person, 5 dog—target bit rate set to 10 Mbps
   3 bike, 1 cat—target bit rate set to 1 Mbps
   3 cat—target bit rate set to 100 kbps

In other embodiments of inventive concepts at least one frame is encoded and transmitted to the control system. The control system may or may not decode the transmitted stream. A MV algorithm is run on the stream (that might be decoded). If an object of a predefined group of classes is detected, the system transmits a target bit rate to the encoder. The target bit rate may be a default bit rate being used, a higher bit rate. If no object that belongs to a specific class is detected, either a default target bit rate is transmitted or no bit rate is transmitted, indicating that the current target bit rate should be maintained. This indication might be a separate signal. A schematic of how such a system could look like is shown in FIG. 5.

In yet other embodiments of inventive concepts, at least one frame is encoded and transmitted to the control part of the system. The control system might decode the transmitted stream. A MV algorithm is run on the stream (that might be decoded). The MV algorithm produces a score indicating how certain it is about the detection and classification of a specific object. Based on the scores for different detected objects, it transmits a new target bit rate or a modification of the current target bit rate to the encoder. This can also be achieved using the system illustrated in FIG. 5.

An example of scoring and detection is below:
Single object detected
   If score >0.9->reduce target bit rate by 10%
   If score >0.7 and score <0.9->no change
   If score >0.4 and score <0.7->increase target bit rate by 10%
   If score >0.2 and score <0.4->increase target bit rate by 20%
   If score <0.2->reduce target bit rate by 20%
Multiple objects detected:
   Use same thresholds as for single objects, the score that is closest to 0.4 is used to determine the change in target bit rate
No objects detected:
   Keep target bit rate as is or transmit a new target bit rate

In additional embodiments of inventive concepts, the system is configured to use at least two different bit rates—a high one, a low one, and optionally any number of middle bit rates. The encoder starts encoding using the low bit rate. At the same time, a buffer is filled with the uncompressed sensor output or the encoding with the high bit rate. At least one frame is sent to the control system for analysis. Based on the outcome of the analysis, the control system sends an instruction to the encoder to encode at a specified bit rate. The buffered information is encoded (if not already encoded at the specified bit rate) at the requested bit rate and then stored for possible later review. If nothing of interest is detected, the control system might send an instruction to the encoder indicating to continue using the low bit rate and to dismiss the buffered information. The decision of the control system might be based on what kind of objects are detected or how confident the algorithm is in its decision.

In another embodiment of inventive concepts, the instruction from the control system includes information about which part of the video should be compressed at which bit rate.

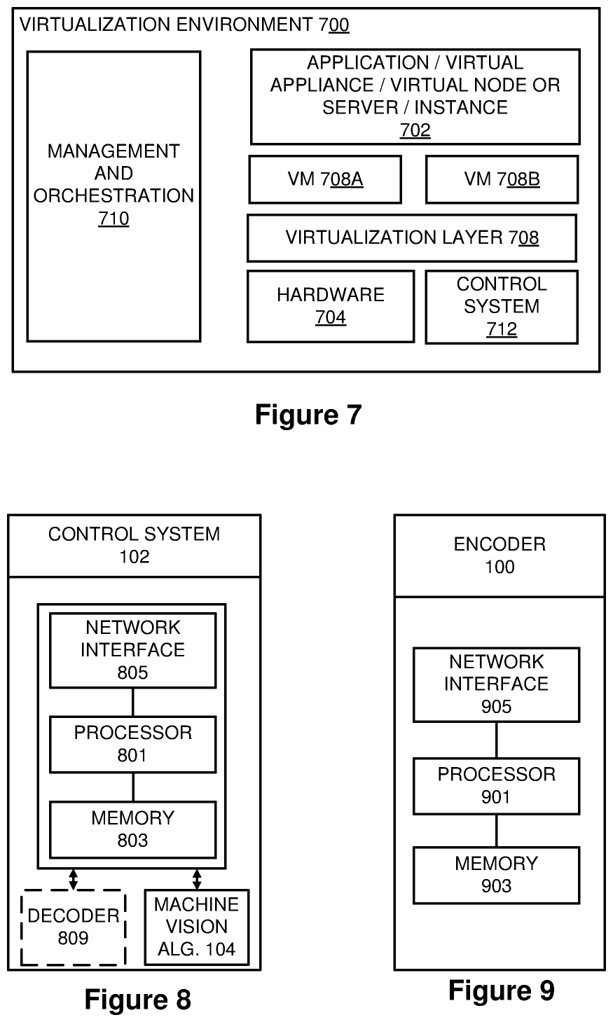

Prior to describing the embodiments of inventive concepts in further detail, FIG. 7 illustrates an example of an operating environment of an encoder 100 that may be used to encode bitstreams as described herein. The encoder 100 receives audio from network 602 and/or from storage 604 and/or from an audio recorder 606, sends frames to control system 102 and receives instructions from control system 102, and encodes the audio into bitstreams as described herein and transmits the encoded audio to decoder 608 via network 610. In some embodiments where the encoder 100 is a distributed encoder, a sending entity 1001 may transmit the encoded audio to decoder 608 via network 610 as indicated by the dashed lines. Storage device 604 may be part of a storage depository of video signals such as a storage repository of a store or a streaming video service, a separate storage component, a component of a mobile device, real-time video from a transportation network, etc. The decoder 608 may be part of a device 612 having a media player 614. The device 612 may be a mobile device, a set-top device, a desktop computer, and the like.

FIG. 7 is a block diagram illustrating a virtualization environment 700 in which functions implemented by some embodiments may be virtualized. In the present context, virtualizing means creating virtual versions of apparatuses or devices such as encoder 100 which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708A and 708B (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g., such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

FIG. 8 is a block diagram illustrating elements of control system 102 configured to receive frames from the encoder 100 and provide a data rate to encoder 100 according to some embodiments of inventive concepts. As shown, control system 102 may include a network interface circuitry 805 (also referred to as a network interface) configured to provide communications with other devices/entities/functions/etc. The control system 102 may also include processor circuitry 801 (also referred to as a processor) coupled to the network interface circuitry 805, and a memory circuitry 803 (also referred to as memory) coupled to the processor circuit. The memory circuitry 803 may include computer readable program code that when executed by the processor circuitry 801 causes the processor circuit to perform operations according to embodiments disclosed herein. The control system 102 may use an optional decoder 809 to decode encoded frames received from the encoder 100 in some embodiments. The control system 102 also uses machine vision algorithm 104 to analyze frames received from the encoder 100 as described herein.

According to other embodiments, processor circuitry 801 may be defined to include memory so that a separate memory circuit is not required. As discussed herein, operations of the control system 102 may be performed by processor 801 and/or network interface 805. For example, processor 801 may control network interface 805 to transmit communications to encoder 100 and/or to receive communications through network interface 805 from one or more other network nodes/entities/servers such as other encoder nodes, depository servers, etc. Moreover, modules may be stored in memory 803, and these modules may provide instructions so that when instructions of a module are executed by processor 801, processor 801 performs respective operations.

FIG. 9 is a block diagram illustrating elements of encoder 100 configured to encode audio frames according to some embodiments of inventive concepts. As shown, encoder 100 may include a network interface circuitry 905 (also referred to as a network interface) configured to provide communications with other devices/entities/functions/etc. The encoder 100 may also include processor circuitry 901 (also referred to as a processor) coupled to the network interface circuitry 905, and a memory circuitry 903 (also referred to as memory) coupled to the processor circuit. The memory circuitry 903 may include computer readable program code that when executed by the processor circuitry 901 causes the processor circuit to perform operations according to embodiments disclosed herein.

According to other embodiments, processor circuitry 901 may be defined to include memory so that a separate memory circuit is not required. As discussed herein, operations of the encoder 100 may be performed by processor 901 and/or network interface 905. For example, processor 901 may control network interface 905 to transmit communications to decoder 608 and/or to receive communications through network interface 905 from one or more other network nodes/entities/servers such as other encoder nodes, control system 102, depository servers, etc. Moreover, modules may be stored in memory 903, and these modules may provide instructions so that when instructions of a module are executed by processor 901, processor 901 performs respective operations.

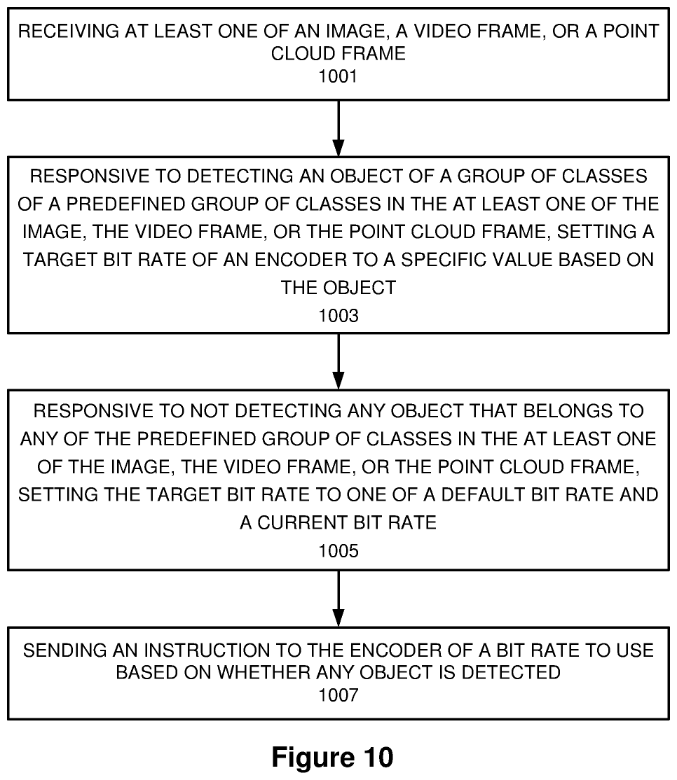

In the description that follows, operations of the control system 102 (implemented using the structure of the block diagram of FIG. 8) will now be discussed with reference to the flow chart of FIG. 10 according to some embodiments of inventive concepts. For example, modules may be stored in memory 803 of FIG. 8, and these modules may provide instructions so that when the instructions of a module are executed by respective communication device processing circuitry 801, processing circuitry 801 performs respective operations of the flow chart.

FIG. 10 illustrates an embodiment of inventive concepts of a control system instructing an encoder of a bit rate to use to encode data based on whether an object is detected. Turning to FIG. 10, in block 1001, the processing circuitry 801 of the control system 102 receives at least one of an image, a video frame, or a point cloud frame. For example, the processing circuitry 801 may receive an encoded video frame from an encoder 100.

In block 1003, the processing circuitry 801, responsive to detecting an object of a group of classes of a predefined group of classes in the at least one of the image, the video frame, or the point cloud frame, sets a target bit rate of an encoder to a specific value based on the object.

For example, the processing circuitry 801 may use the machine vision algorithm to detect any objects in the at least one of the image, the video frame, or the point cloud frame. Using the example of the group of classes described above, if a car, person or bus is detected, the processing circuitry 801 sets the target bit rate to 10 Mbps.

Thus, responsive to the object being in a first predefined group comprising a car, a bus, and a person, the processing circuitry 801 sets the target bit rate to a first value in some embodiments of inventive concepts. Responsive to the object being in a second predefined group comprising a bike, a dog, and a train, setting the target bit rate to a second value different from the first value. The first value in some embodiments in higher than the second value.

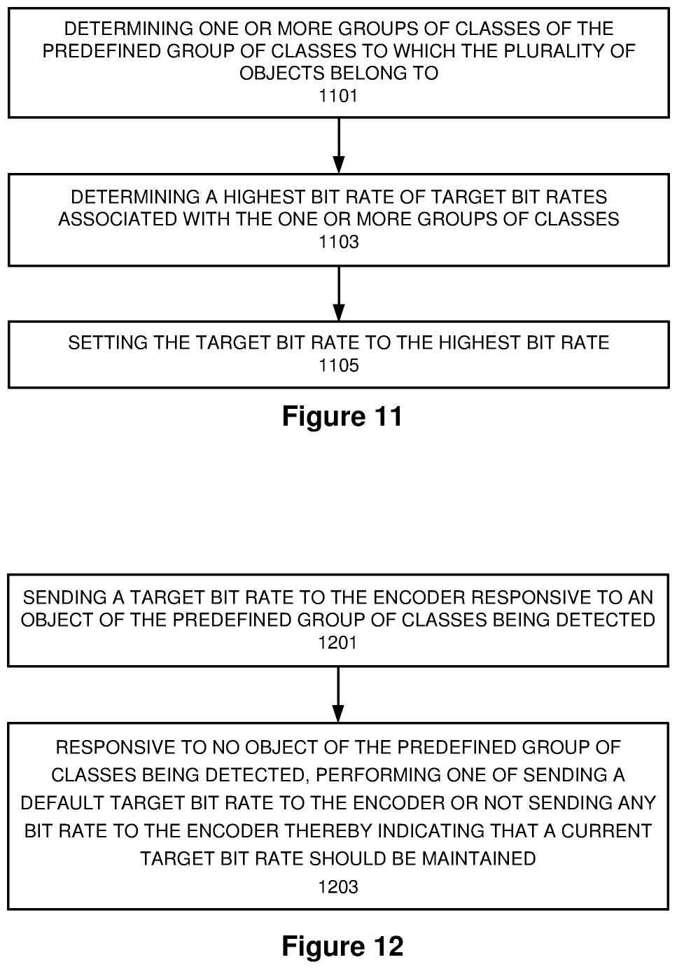

There may be multiple objects detected. FIG. 11 illustrates an embodiment of how the control system 102 handles multiple objects. Turning to FIG. 11, in block 1101, the processing circuitry 801 determines one or more groups of classes of the predefined group of classes to which the plurality of objects (i.e., the multiple objects) belong to. In block 1103, the processing circuitry 801 determines a highest bit rate of target bit rates associated with the one or more groups of classes. In block 1105, the processing circuitry 801 sets the target bit rate to the highest bit rate.

Returning to FIG. 10, in block 1005, responsive to not detecting any object that belongs to any of the predefined group of classes in the at least one of the image, the video frame, or the point cloud frame, the processing circuitry 801 sets the target bit rate to one of a default bit rate and a current bit rate

In block 1007, the processing circuitry 801 sends an instruction to the encoder of a bit rate to use based on whether any object is detected. FIG. 12 illustrates an embodiment of sending the instruction to the encoder.

In other embodiments, the processing circuitry 801, in sending the instruction, sends information about which part of a video should be compressed at which bit rate.

Turning to FIG. 12, in block 1201, the processing circuitry 801 sends a target bit rate to the encoder 100 responsive to an object of the predefined group of classes being detected. In block 1203, the processing circuitry 801, responsive to no object of the predefined group of classes being detected, performs one of sending a default target bit rate to the encoder or not sending any bit rate to the encoder 100 thereby indicating that a current target bit rate should be maintained. Thus, the encoder 100 may receive an instruction to encode at the default target bit rate or not receive any instruction and thus maintain the current target bit rate.

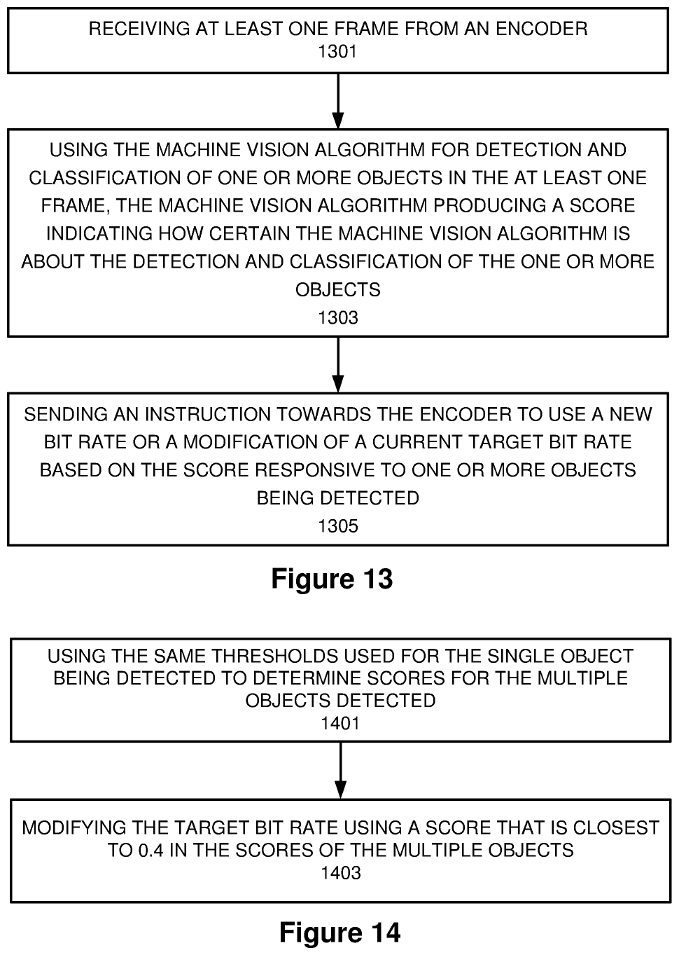

FIG. 13 illustrates another embodiment of inventive concepts where the control system 102 sets the bit rate based on a score. Turning to FIG. 13, in block 1301, the processing circuitry 801 receives at least one frame from an encoder.

In block 1303, the processing circuitry 801 uses the machine vision algorithm 104 for detection and classification of one or more objects in the at least one frame, the machine vision algorithm 104 producing a score indicating how certain the machine vision algorithm 104 is about the detection and classification of the one or more objects.

In block 1305, the processing circuitry 801 sends an instruction towards. the encoder to use a new bit rate or a modification of a current target bit rate based on the score responsive to one or more objects being detected.

Responsive to a single object being detected, the processing circuitry 801 modifies the current target bit rate by:
responsive to the score being greater than 0.9, reducing the target bit rate by 10%
responsive to the score being greater than 0.7 and less than 0.9, not changing the target bit rate;
responsive to the score being greater than 0.4 and less than 0.7, increasing the target bit rate by 10%
responsive to the score being greater than 0.2 and less than 0.4, increasing the target bit rate by 20%
responsive to the score being less than 0.2, reducing the target bit rate by 20%.

FIG. 14 illustrates an embodiment of inventive concepts of modifying the target bit rate when multiple objects are detected. Turning to FIG. 14, in block 1401, the processing circuitry 8081 uses the same thresholds used for the single object being detected to determine scores for the multiple objects detected. In block 1403, the processing circuitry 801 modifies the target bit rate using a score that is closest to 0.4 in the scores of the multiple objects.

In some embodiments, responsive to no objects being detected, the processing circuitry 801 performs one of sending an instruction towards the encoder to use a current target bit rate or a new target bit rate or not sending an instruction thereby indicating that a current target bit rate should be maintained.

In other embodiments, the processing circuitry 801, in sending the instruction, sends information about which part of a video should be compressed at which bit rate.

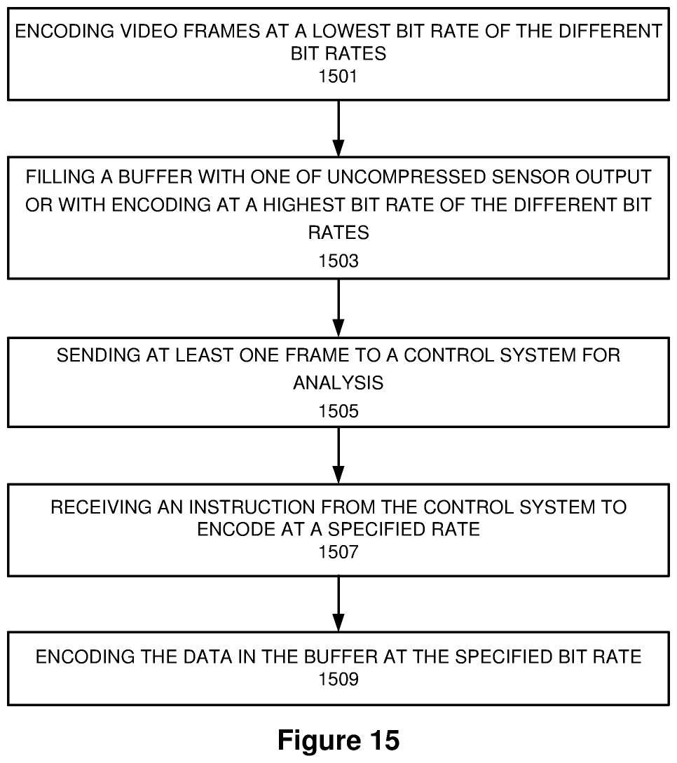

Operations of the encoder 102 (implemented using the structure of FIG. 9) will now be discussed with reference to the flow chart of FIG. 15 according to some embodiments of inventive concepts. For example, modules may be stored in memory 903 of FIG. 9, and these modules may provide instructions so that when the instructions of a module are executed by respective control system processing circuitry 901, processing circuitry 901 performs respective operations of the flow chart.

FIG. 15 illustrates an embodiment of inventive concepts of an encoder using different bit rates in encoding. Turning to FIG. 15, in block 1501, the processing circuitry 901 encodes video frame at a lowest bit rate of the different bit rates. In other embodiments, a bit rate higher than the lowest bit rate may be used.

In block 1503, the processing circuitry 901 fills a buffer with one of uncompressed sensor output or with encoding at a highest bit rate of the different bit rates. In other embodiments, a bit rate lower than the highest bit rate may be used.

In block 1505, the processing circuitry 901 sends at least one frame to a control system 102 for analysis. In block 1507, the processing circuitry 901 receives an instruction from the control system to encode at a specified bit rate. In block 1509, the processing circuitry 901 encodes data in the buffer at the specified bit rate.

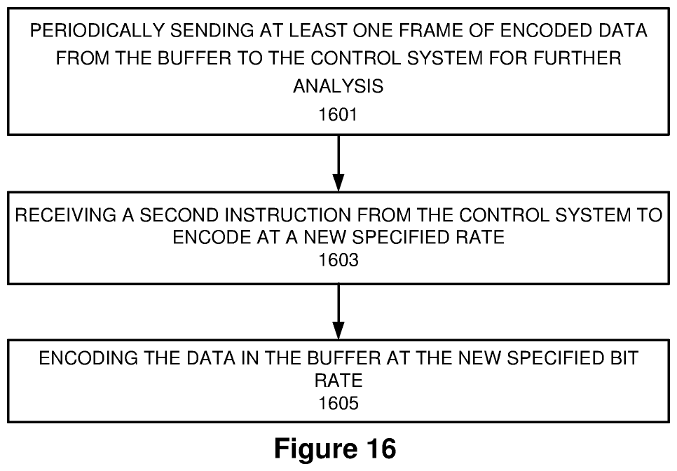

FIG. 16 illustrates an embodiment of inventive concepts where the encoder 100 periodically sends frames to the control system 102 to see if the bit rate should be updated. Turning to FIG. 16, in block 1601, the processing circuitry 901 periodically sends at least one frame of encoded data from the buffer to the control system for further analysis. In block 1603, the processing circuitry 901 receives a second instruction from the control system 102 to encode at a new specified bit rate. In block 1605, the processing circuitry 901 encodes the data in the buffer at the new specified bit rate. Note that the new specified bit rate in some embodiments may be the same bit rate as the current bit rate.

In some embodiments, the second instruction indicates the new specified bit rate is the lowest bit rate and instructs the encoder to dismiss the data in the buffer

In other embodiments, the processing circuitry 801, in sending the instruction, sends information about which part of a video should be compressed at which bit rate.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,”, which derives from the Latin phrase “exempli gratia,” may be used to introduce or specify a general example or examples of a previously mentioned item and is not intended to be limiting of such item. The common abbreviation “i.e.,”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Explanations are provided below for various abbreviations/acronyms used in the present disclosure.

| Abbreviation | Explanation |
|---|---|
| FPS | Frames per Second |
| GOP | Group of Pictures |
| MSE | Mean Square Error |
| MS-SSIM | Multi-Scale Structural Similarity |
| MV | Machine Vision |
| PSNR | Peak Signal-to-Noise Ratio |
| ROI | Region of Interest |
| VBR | Variable Bit Rate |

### REFERENCES

[1] C. Hollmann, P. Wennersten, J. Ström, L. Litwic. “[VCM] VCM-based rate-distortion optimization for VVC”, ISO/IEC JTC 1 SC29 WG2 m56634, April 2021
[2] Axis Communications. “Axis Zipstream technology”, Whitepaper, January 2018
[3] Benedek, Csaba. “3D people surveillance on range data sequences of a rotating Lidar.” Pattern Recognition Letters 50 (2014): 149-158.

1. A method, performed by a control system having a machine vision algorithm, the method comprising:
receiving at least one of an image, a video frame, or a point cloud frame;
responsive to detecting an object of a group of classes of a predefined group of classes in the at least one of the image, the video frame, or the point cloud frame, setting a target bit rate of an encoder to a specific value based on the object;
responsive to not detecting any object that belongs to any of the predefined group of classes in the at least one of the image, the video frame, or the point cloud frame, setting the target bit rate to one of a default bit rate and a current bit rate; and
sending an instruction to the encoder of a bit rate to use based on whether any object is detected.

2. The method of claim 1, wherein setting the target bit rate of the encoder to the specific value comprises:
responsive to the object being in a first predefined group, setting the target bit rate to a first value; and
responsive to the object being in a second predefined group, setting the target bit rate to a second value different from the first value.

3. The method of claim 2, wherein the first value is higher than the second value.

4. The method of claim 1, wherein responsive to there being a plurality of objects detected:
determining one or more groups of classes of the predefined group of classes to which the plurality of objects belong to;
determining a highest bit rate of target bit rates associated with the one or more groups of classes; and
setting the target bit rate to the highest bit rate.

5. The method of claim 1, wherein receiving at least one of an image, a video frame, or a point cloud frame comprises receiving an encoded image, an encoded video frame or an encoded point cloud frame from the encoder.

6. The method of claim 5 wherein sending an indication to the encoder of a bit rate to use comprises:
sending a target bit rate to the encoder responsive to an object of the predefined group of classes being detected; and
responsive to no object of the predefined group of classes being detected, performing one of sending a default target bit rate to the encoder or not sending any bit rate to the encoder thereby indicating that a current target bit rate should be maintained.

7. The method of claim 1, wherein sending the instruction to the encoder of a bit rate to use comprises sending information about which part of a video sequence or a point cloud sequence should be compressed at which bit rate.

8. A method performed by a control system having a machine vision algorithm, the method comprising:
receiving at least one frame from an encoder;
using the machine vision algorithm for detection and classification of one or more objects in the at least one frame, the machine vision algorithm producing a score indicating how certain the machine vision algorithm is about the detection and classification of the one or more objects;
sending an instruction towards the encoder to use a new bit rate or a modification of a current target bit rate based on the score responsive to one or more objects being detected.

9. The method of claim 8, wherein responsive to no objects being detected, performing one of sending an instruction towards the encoder to use a current target bit rate or a new target bit rate or not sending an instruction thereby indicating that a current target bit rate should be maintained.

10. The method of claim 8, wherein sending the instruction to the encoder of a bit rate to use comprises sending information about which part of a video sequence or a point cloud sequence should be compressed at which bit rate.

11. A method performed by an encoder configured to use different bit rates, the method comprising:
encoding video frames at a lowest bit rate of the different bit rates;
filling a buffer with one of uncompressed sensor output or with encoding at a highest bit rate of the different bit rates;
sending at least one frame to a control system for analysis;
receiving an instruction from the control system to encode at a specified bit rate; and
encoding data in the buffer at the specified bit rate.

12. The method of claim 11, further comprising:
periodically sending at least one frame of encoded data from the buffer to the control system for further analysis;
receiving a second instruction from the control system to encode at a new specified bit rate; and
encoding data in the buffer at the new specified bit rate.

13. The method of claim 12 wherein the second instruction indicates the new specified bit rate as the lowest bit rate and instructs the encoded to dismiss the data in the buffer.

14. The method of claim 11, wherein the instruction and the second instruction specify which part of a video sequence or a point cloud sequence should be compressed at which bit rate.

15.-22. (canceled)
